(19) United States
(12) Patent Application Publication
(10) Pub. No.: US 2019/0270627 A1
(43) Pub. Date: Sep. 5, 2019

(54) PORTABLE WORKSTATION WITH LIFTING PLATFORM AND TURNTABLE

(71) Applicant: CIRCUIT BREAKER LIFT CORP., Airdrie (CA)

(72) Inventor: John HODSON, Airdrie, CA (US)

(73) Assignee: CIRCUIT BREAKER LIFT CORP., Airdrie (CA)

(21) Appl. No.: 16/290,492

(22) Filed: Mar. 1, 2019

Related U.S. Application Data
(60) Provisional application No. 62/638,047, filed on Mar. 2, 2018.

(51) Int. Cl. B66F 9/07; B66F 9/12; B66F 9/075; B66F 9/19; B66F 9/08; B66F 9/20

(52) U.S. Cl. CPC B66F 9/07; B66F 9/127; B66F 9/07509; B66F 9/07559; B66F 9/20; B66F 9/08; B66F 9/07572; B66F 9/07554; B66F 9/19

(57) ABSTRACT

There is disclosed a portable work station comprising a generally vertical frame mounted to a base having wheels mounted thereon which allow the vertical frame, and a lifting platform mounted on the vertical frame, to be maneuvered across a flat floor surface. Preferably, the wheels are freely rotatable in any direction to allow the base to be easily manoeuvered on a flat floor surface. The wheels may be powered with motors and controlled via an operator control to move the base and the lifting platform into any desired height and orientation with a high degree of manoeuverability.

### CROSS-REFERENCE TO RELATED APPLICATIONS

This application claims the benefit of U.S. Provisional Application Ser. No. 62/638,047 filed on Mar. 2, 2018.

### FIELD

The present invention relates generally to portable workstations, and more particularly to workstations having lifting mechanisms.

### BACKGROUND

Lifting equipment is required in industrial applications in which heavy work pieces need to be handled. As an illustrative example, in certain applications in which heavy duty power circuit breakers are required to be serviced and or replaced, the power circuit breaker hardware could weigh many hundreds of pounds. Servicing such circuit breakers, even with the aid of conventional lifts, can be a difficult task given the need to access the circuit breakers, and to insert or remove them from their cell rails. Conventional lift designs fail to provide an adequate solution.

What is needed is an improved portable workstation which addresses at least some of the limitations in existing lift equipment.

### SUMMARY

The present disclosure describes a novel portable workstation with a lifting platform having a turntable mounted thereon, the workstation adapted to allow an operator to work with heavy equipment weighing many hundreds of pounds at any desired height and orientation.

In an embodiment, the portable workstation comprises a generally vertical frame mounted to a base having wheels mounted thereon which allow the vertical frame, and the lifting platform mounted on the vertical frame, to be maneuvered across a flat floor surface. Preferably, the wheels are freely rotatable in any direction to allow the base to be easily manoeuvered on a flat floor surface. The wheels may be powered with motors and controlled via an operator control to move the base and the lifting platform into any desired height and orientation with a high degree of manoeuverability.

In an embodiment, the portable workstation further comprises a lifting mechanism which is adapted to lift and lower a lifting platform which is slidably mounted to vertical rails provided on the generally vertical frame. The lifting mechanism may be powered with an electro-hydraulic lift mechanism which allows the platform to slide along the vertical rails to which the platform is mounted. Alternatively, a rack and teeth mechanism may be used to move the platform along the vertically mounted rails, or a pulley mechanism with a chain or a tape which lifts the platform from above utilizing a pulley wheel may also be used. If a pulley mechanism is used, a counterweight may be utilized to better balance the platform and to better handle the load of any work piece or equipment mounted thereon.

In another embodiment, the lifting platform provides a turntable mounted thereon which allows a tool or a work piece to be placed on a turntable mounted thereon, and rotated as desired to any orientation to allow access to all sides of the power circuit breaker. The turntable may be balanced on metal ball bearings, for example, which allows the turntable to turn smoothly, while bearing potentially many hundreds of pounds. The turntable may also be motorized and controlled via an operator control to rotate the tool or the work piece to an appropriate height and orientation in order to provide access.

In an embodiment, the lifting platform and the turntable configured to allow the portable workstation to be maneuvered into position to lift out heavy machinery, such as a power circuit breaker, from its installed position. The turntable and the lifting platform may both be operator controlled to position the base beneath the work piece or machinery.

Advantageously, the portable lifting platform of the present invention allows a heavy work piece to be readily positioned by adjusting the height, and by rotating the work piece on the turntable to any desired orientation. As an example, and not by way of limitation, the portable platform is particularly well suited for removal and insertion of heavy circuit breakers which often weigh hundreds of pounds.

In this respect, before explaining at least one embodiment of the invention in detail, it is to be understood that the invention is not limited in its application to the details of construction and to the arrangements of the components set forth in the following description or the examples provided therein, or illustrated in the drawings. Therefore, it will be appreciated that a number of variants and modifications can be made without departing from the teachings of the disclosure as a whole. Therefore, the present system, method and apparatus is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present system and method will be better understood, and objects of the invention will become apparent, when consideration is given to the following detailed description thereof. Such description makes reference to the annexed drawings, wherein:

FIG. 1 shows a front left perspective view of a portable lifting platform in accordance with an embodiment.

FIG. 2 shows a front right perspective view of the portable lifting platform of FIG. 1.

FIG. 3 shows a left perspective view of the portable lifting platform of FIG. 1.

FIG. 4 shows a back perspective view of the portable lifting platform of FIG. 1.

FIG. 5 shows a front right perspective view of the portable lifting platform with the platform raised to its top position.

FIG. 6 shows a right perspective view of the portable lifting platform of FIG. 5 with the platform raised to its top position.

FIG. 7 shows a rear right perspective view of the portable lifting platform of FIG. 5 with the platform raised to its top position.

FIG. 8 shows a close up view of a turntable locking device in accordance with an embodiment.

FIG. 9 shows a close up view of a pair of removable lifting blocks on top of the turntable in accordance with an embodiment.

In the drawings, embodiments are illustrated by way of example. It is to be expressly understood that the description and drawings are only for the purpose of illustration and as an aid to understanding, and are not intended as describing the accurate performance and behavior of the embodiments and a definition of the limits of the invention.

### DETAILED DESCRIPTION

As noted above, the present invention relates to a novel portable workstation with a lifting platform having a turntable mounted thereon.

An illustrative embodiment of the lifting platform will now be described with reference to the figures.

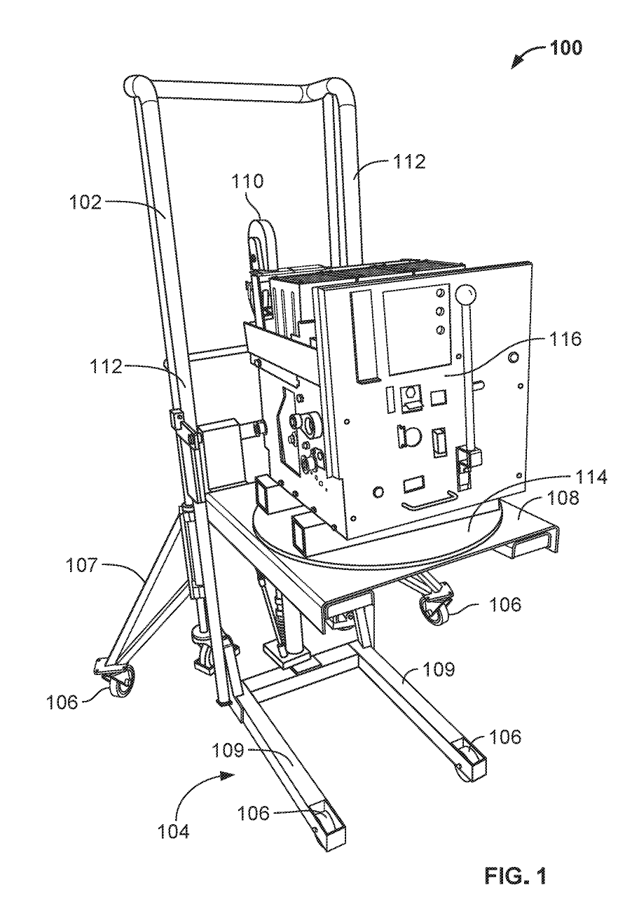

Referring to FIG. 1, shown is an illustrative embodiment in one possible configuration. It is to be understood that the dimensions of this embodiment are shown by example, and may be modified to be taller, shorter, wider, or narrower than shown in any dimension, to suit any particular application. FIG. 1 shows a front left perspective view of a portable lifting platform 100 in accordance with an embodiment. The portable workstation comprises a generally vertical frame 102 mounted to a base 104 having a pair of extending feet 109 with wheels 106 mounted thereon which allow the vertical frame 102, and platform 108 mounted on the vertical frame 102, to be maneuvered across a flat floor surface. Preferably, at least some of the wheels 106 are freely rotatable in any direction to allow the base 104 to be easily manoeuvered on a flat floor surface. Once the portable lifting platform 100 is in the proper location, outriggers or extending stand supports 107 can be extended to provide additional rear and lateral support on both sides.

In an embodiment, the wheels 106 may be powered with motors (not shown) and controlled via an operator control to move the base 104 and the platform 108 into any desired height and orientation with a high degree of maneuverability.

In an embodiment, the portable workstation further comprises a lifting mechanism 110 which is adapted to lift and lower the platform 108 which is slidably mounted to vertical rails 112 provided on the generally vertical frame 102. In an embodiment, a pair of parallel vertical rails 112 are provided on the generally vertical frame 102. The lifting mechanism 110 may be powered with an electro-hydraulic lift mechanism which allows the platform 108 to slide along the vertical rails 112 to which the platform 108 is mounted.

In another embodiment, the platform 108 provides a turntable 114 mounted thereon, which allows a tool or a work piece (e.g. a circuit breaker) 116 to be placed on the turntable 114, and rotated as desired to any height and any orientation on the rotatable turntable 114 to allow access to all sides of the power circuit breaker 116. The turntable 114 may be balanced on metal ball bearings, for example, which allows the turntable 114 to turn smoothly, while bearing the weight of a work piece weighing potentially many hundreds of pounds, or up to a thousand pounds. Once the work piece is in a desired orientation, the turntable 114 may be locked to keep the work piece in that orientation. The turntable 114 may also be motorized and controlled via an operator control to rotate the tool or the work piece to an appropriate height and orientation in order to provide access.

In an embodiment, the lifting platform 108 and the turntable 114 are configured to allow the portable workstation 100 to be maneuvered into position to lift out heavy machinery, such as a power circuit breaker, from its installed position. The turntable and the lifting platform may both be operator controlled to position the base beneath the work piece or machinery mounted on a shelf or bracket. For example, the portable work station 100 is well suited for removing, servicing, and reinstalling heavy duty industrial circuit breakers weighing hundreds of pounds from their “cell rails”, easily from the front or side. The portable work station 100 is designed to meet the majority of existing circuit breaker weights, dimensions and switchgear heights without modification, and is portable enough for truck or van transport to onsite field locations.

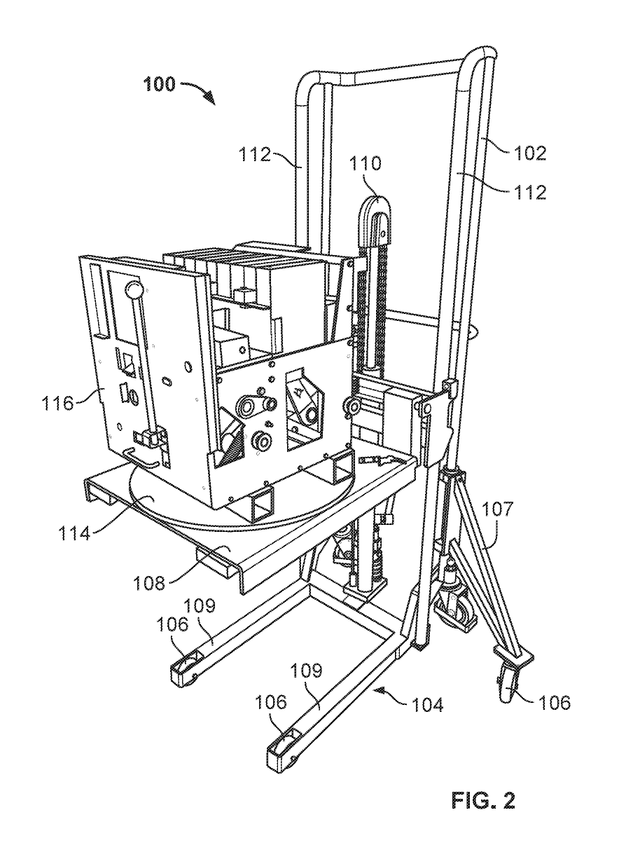

Now referring to FIG. 2, shown is a front right perspective view of the portable lifting platform of FIG. 1. In this view, the lifting mechanism 110 is shown more clearly. By way of example, the lifting mechanism in this case uses a pulley mechanism with a chain, similar to a bicycle chain, which lifts the platform 108 from above utilizing a pulley wheel. If a pulley mechanism is used, a counterweight may be utilized to better balance the platform 108 and to better handle the load of any work piece or equipment 116 mounted thereon. While an illustrative lifting mechanism 110 is shown, it will be appreciated that various other types of lifting mechanisms may also be used.

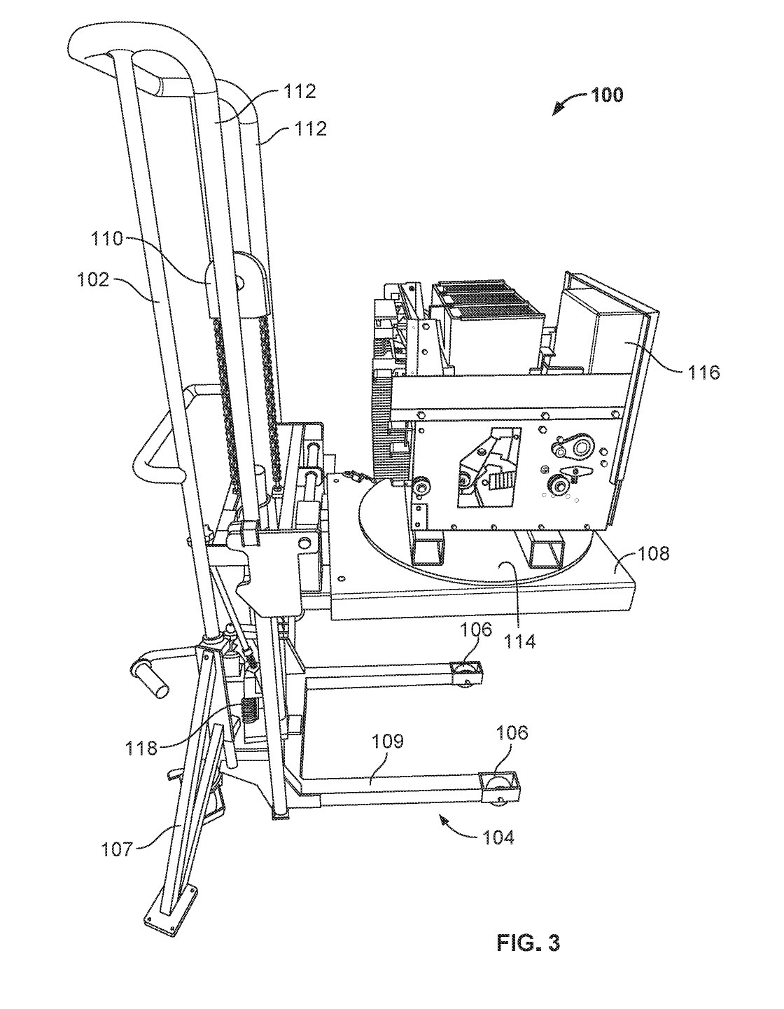

FIG. 3 shows a left perspective view of the portable lifting platform of FIG. 1. In this view, the rails 112 on which the platform 108 is mounted is shown more clearly. The lifting mechanism 110 is also shown from a side view, with a ratchet mechanism 118 used to manually or automatically operate the lifting mechanism 110. In an embodiment, the lifting mechanism 110 may be foot operated, and may be assisted by an electric motor, for example.

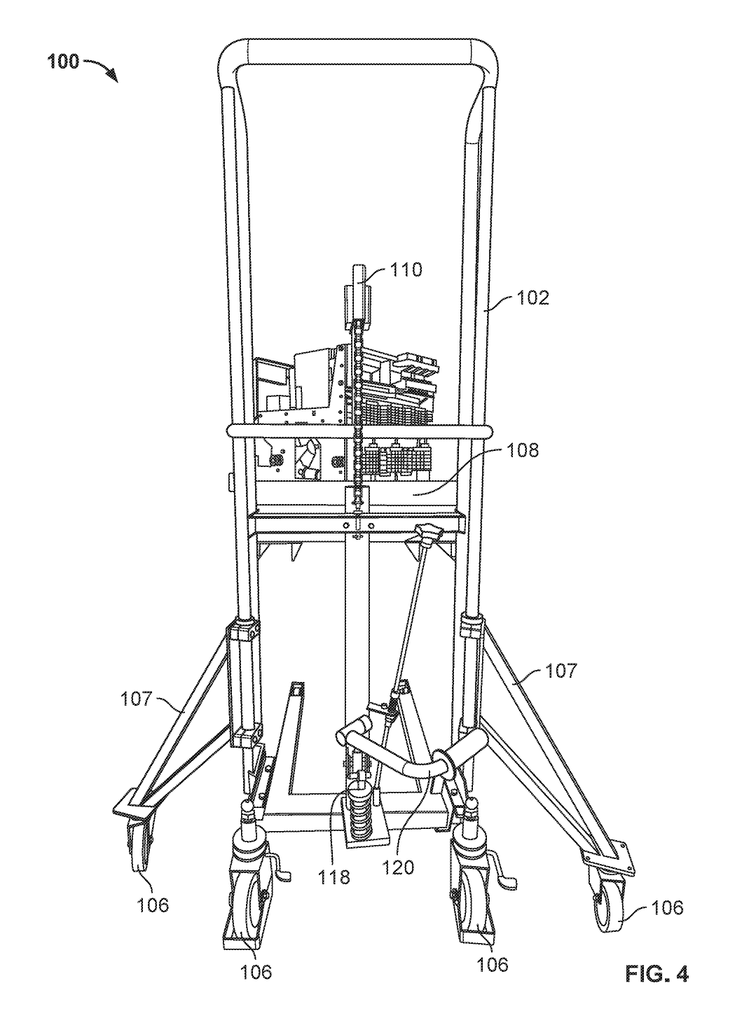

FIG. 4 shows a back perspective view of the portable lifting platform 100 of FIG. 1. In this view, the lifting mechanism is shown more clearly from the back, with the ratchet mechanism 118 as seen from the back with a handle 120 for operating the ratchet mechanism 118.

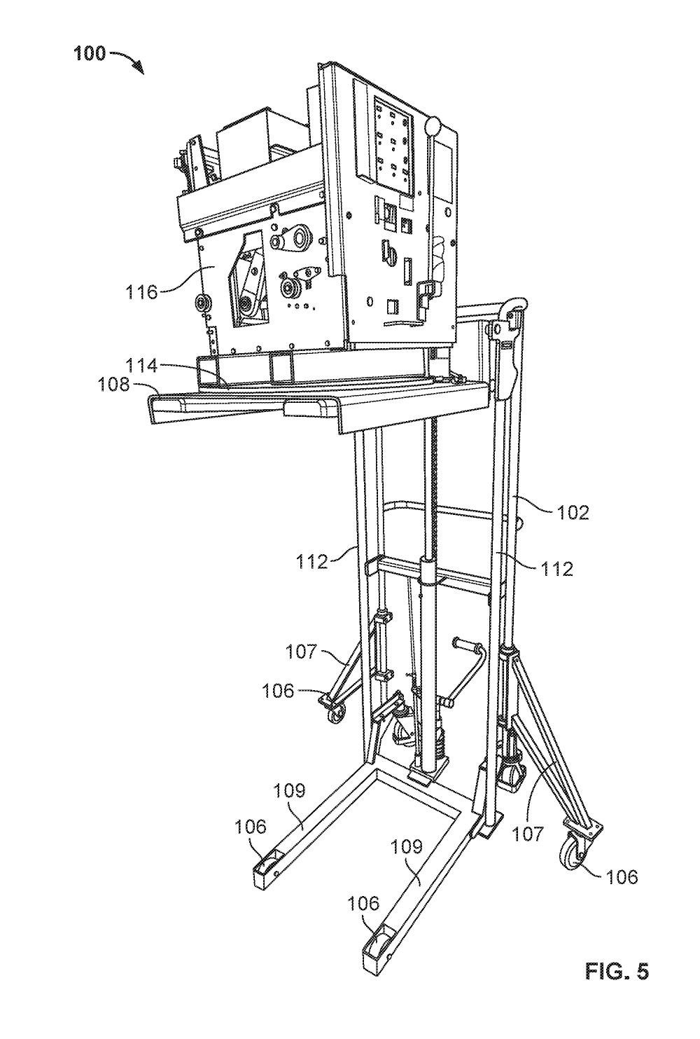

FIG. 5 shows a front right perspective view of the portable lifting platform with the platform raised to its top position. In this view, the purpose of the feet 109, and extending stand supports 107 can be better appreciated, as these stabilize the portable lifting mechanism 110 with a broader base.

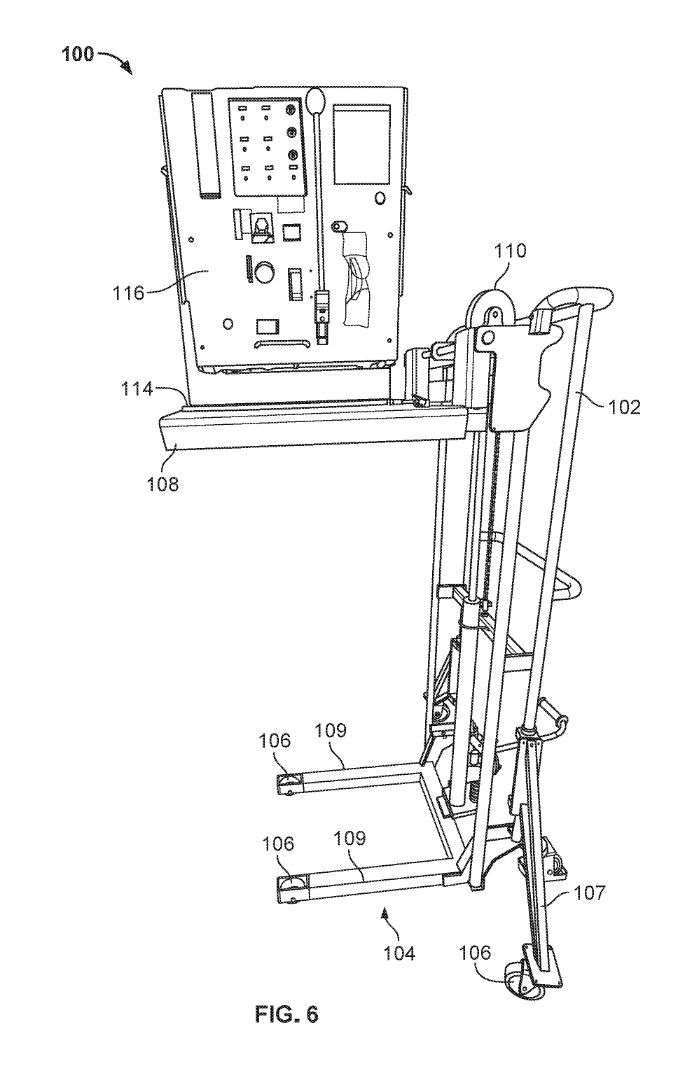

Now referring to FIG. 6, shown is a right perspective view of the portable lifting platform of FIG. 5 with the platform raised to its top position. Again, in this view, the purpose of the feet 109, and extending stand supports 107 can be better appreciated, as these provide the portable lifting platform 100 with greater stability, as the work piece 116 is raised higher. In this view, it can also be seen that the lifting mechanism 110 now has the pulley positioned at its highest point, near the top of the vertical frame 102.

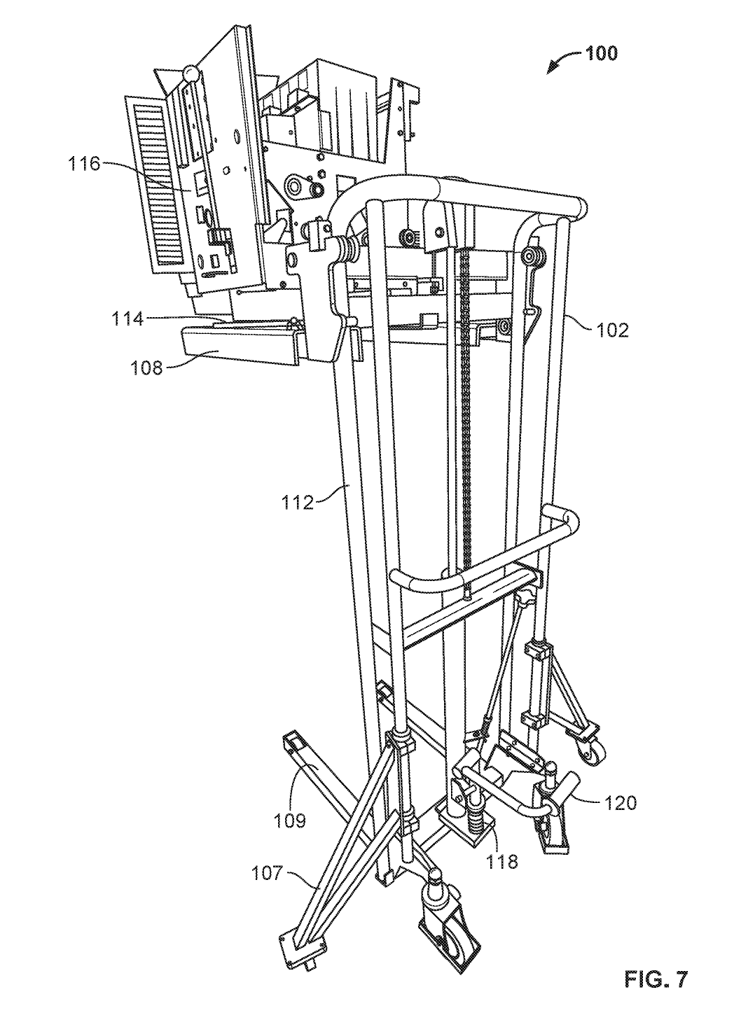

FIG. 7 shows a rear right perspective view of the portable lifting platform of FIG. 5 with the platform raised to its top position.

In terms of safety features, the portable lifting platform 100 allows heavy items or work pieces up to 800 pounds to be moved easily by one person. Its highly maneuverable design allows the lifting platform to be carefully positioned to prevent any damage to expensive equipment. The design also eliminates potential harm to personnel in maneuvering difficult to handle heavy equipment which may have numerous pinch and cut points. The design also eliminates strains and lifting by personnel, and allows for an ergonomic work station which can adjust the height and orientation of the work piece to its desired location.

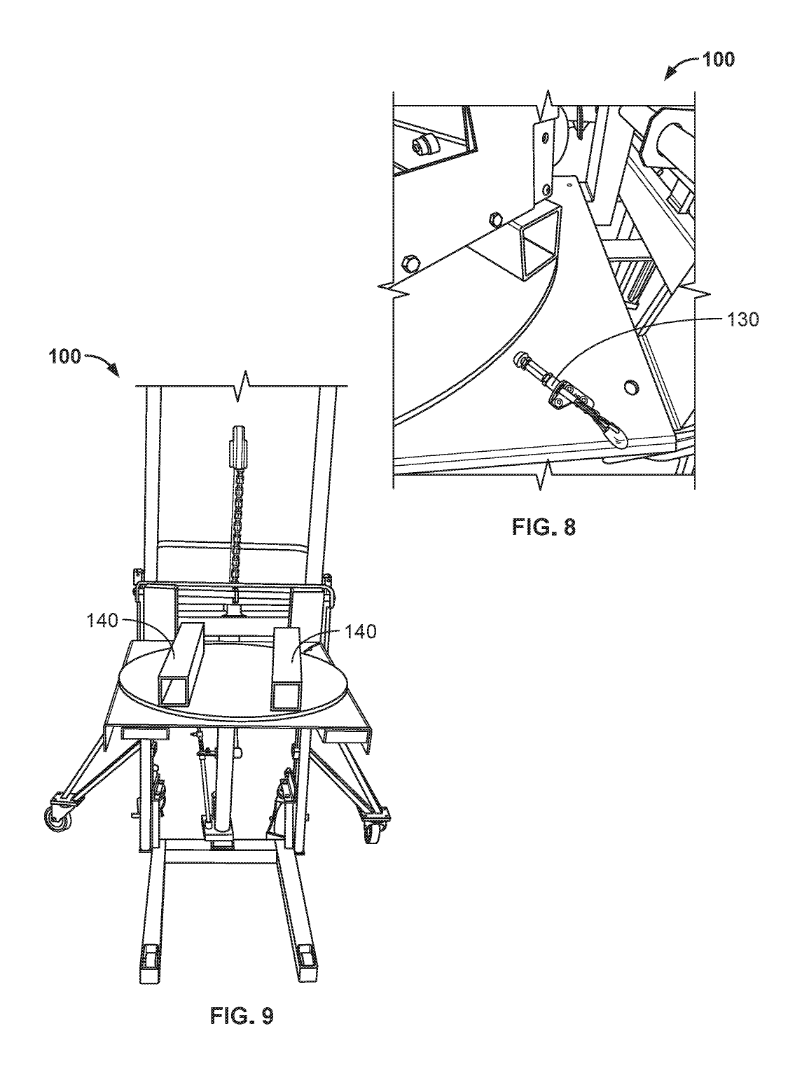

FIG. 8 shows a close up view of a turntable locking device 130 in accordance with an embodiment. When the turntable locking device 130 is engaged, it prevents the turntable 114 from turning. This is particularly useful when it is desirable to lock the position of a heavy work piece as it is being worked on.

FIG. 9 shows a close up view of a pair of removable lifting blocks 140 on top of the turntable in accordance with an embodiment. These removable locking blocks help prevent damage to the work piece while it is on the turntable 114, and also allows access to the underside of the work piece while it is being worked on.

While an illustrative example of the utility of the portable lifting platform 100 has been described, it will be appreciated that it may be used in a wide variety of applications by field service companies and utilities in many industries, including commercial, institutional, mining and others.

The illustrative examples show a portable lifting platform 100 which can handle up to 1000 pounds. However, larger versions of the platform could be designed to handle even greater weights.

Thus, in an aspect, there is provided a portable workstation, comprising: a vertical frame; a base with wheels supporting the vertical frame; a platform mounted on the vertical frame; a lifting mechanism for lifting and lowering the platform; and a turntable mounted on the platform to rotate a work piece placed thereon.

In an embodiment, the vertical frame provides at least one vertical rail along which the lifting platform is slidably mounted.

In another embodiment, the vertical frame provides a pair of parallel vertical rails along which the lifting platform is slidably mounted.

In another embodiment, at least some of the wheels are freely rotating on a vertical axis, thereby to provide increased maneuverability.

In another embodiment, at least some of the wheels are powered with motors controllable by an operator control.

In another embodiment, at least some of the wheels include brakes for preventing the wheels from rotating.

In another embodiment, the lifting mechanism is an electro-hydraulic lift mechanism.

In another embodiment, the lifting mechanism is an electro-hydraulic lift mechanism.

In another embodiment, the lifting mechanism is a pulley mechanism with a chain or tape attached to the platform.

In another embodiment, the lifting mechanism utilizes a counterweight to improve balance of the platform and a load on the platform.

In another embodiment, the portable workstation further comprises a ratchet mechanism for manually ratcheting up the platform.

In another embodiment, the turntable is mounted on ball bearings to allow the turntable to turn even while supporting a workpiece thereon.

In another embodiment, the turntable is motorized and adapted to be controlled by an operator to position a workpiece thereon.

In another embodiment, the portable workstation further comprises a turntable locking device for locking the turntable in a desired orientation.

In another embodiment, the position of the base, the height of the platform, and the rotation of the turntable are all adapted to be adjusted by a user to position and properly orient a workpiece thereon.

In another embodiment, the platform and the turntable are configured to support a power circuit breaker.

In another embodiment, the platform and turntable are configured to support a work piece up to 1000 lbs.

In another embodiment, the platform and turntable are configured to support a work piece of at least 800 lbs.

In another embodiment, the portable workstation further comprises outriggers or extending stand supports for bracing the base and the vertical frame.

In another embodiment, the outriggers or extending stand supports are adjustable to reduce the footprint when not in use.

While illustrative embodiments have been described above by way of example, it will be appreciated that various changes and modifications may be made without departing from the scope of the system and method, which is defined by the following claims.

1. A portable workstation, comprising:
a vertical frame;
a base with wheels supporting the vertical frame;
a platform mounted on the vertical frame;
a lifting mechanism for lifting and lowering the platform; and
a turntable mounted on the platform to rotate a work piece placed thereon.

2. The portable workstation of claim 1, wherein the vertical frame provides at least one vertical rail along which the lifting platform is slidably mounted.

3. The portable workstation of claim 2, wherein the vertical frame provides a pair of parallel vertical rails along which the lifting platform is slidably mounted.

4. The portable workstation of claim 1, wherein at least some of the wheels are freely rotating on a vertical axis, thereby to provide increased maneuverability.

5. The portable workstation of claim 1, wherein at least some of the wheels are powered with motors controllable by an operator control.

6. The portable workstation of claim 1, wherein at least some of the wheels include brakes for preventing the wheels from rotating.

7. The portable workstation of claim 1, wherein the lifting mechanism is an electro-hydraulic lift mechanism.

8. The portable workstation of claim 1, wherein the lifting mechanism is an electro-hydraulic lift mechanism.

9. The portable workstation of claim 1, wherein the lifting mechanism is a pulley mechanism with a chain or tape attached to the platform.

10. The portable workstation of claim 9, wherein the lifting mechanism utilizes a counterweight to improve balance of the platform and a load on the platform.

11. The portable workstation of claim 1, further comprising a ratchet mechanism for manually ratcheting up the platform.

12. The portable workstation of claim 1, wherein the turntable is mounted on ball bearings to allow the turntable to turn even while supporting a workpiece thereon.

13. The portable workstation of claim 1, wherein the turntable is motorized and adapted to be controlled by an operator to position a workpiece thereon.

14. The portable workstation of claim 1, further comprising a turntable locking device for locking the turntable in a desired orientation.

15. The portable workstation of claim 1, wherein the position of the base, the height of the platform, and the rotation of the turntable are all adapted to be adjusted by a user to position and properly orient a workpiece thereon.

16. The portable workstation of claim 1, wherein the platform and the turntable are configured to support a power circuit breaker.

17. The portable workstation of claim 1, wherein the platform and turntable are configured to support a work piece up to 1000 lbs.

18. The portable workstation of claim 1, wherein the platform and turntable are configured to support a work piece of at least 800 lbs.

19. The portable workstation of claim 1, further comprising outriggers or extending stand supports for bracing the base and the vertical frame.

20. The portable workstation of claim 19, wherein the outriggers or extending stand supports are adjustable to reduce the footprint when not in use.
